(19) United States
(12) Patent Application Publication
(10) Pub. No.: US 2017/0092007 A1
(43) Pub. Date: Mar. 30, 2017

(54) Methods and Devices for Providing Enhanced Visual Acuity

(71) Applicant: SuperEye, Inc., Phoenix, AZ (US)

(72) Inventors: Jeffrey Louis Goldberg, San Diego, CA (US); Abraham M. Sher, Bal Harbour, FL (US); Daniel A. Bock, Paradise Valley, AZ (US)

(21) Appl. No.: 15/275,080

(22) Filed: Sep. 23, 2016

Related U.S. Application Data
(60) Provisional application No. 62/248,363, filed on Oct. 30, 2015.
(60) Provisional application No. 62/232,244, filed on Sep. 24, 2015.

(51) Int. Cl. G06T 19/00; G06T 3/40; G02B 27/01; G06K 9/00; G06K 9/62; G06F 3/044; G06T 5/00

(52) U.S. Cl. CPC G06T 19/006; G06F 3/044; G06T 3/4092; G06T 5/00; G06K 9/0061; G06K 9/00335; G06K 9/6201; G02B 27/0172; G02B 27/0179; G02B 2027/0178; G02B 2027/0138; G02B 2027/014; G02B 2027/0187; G02B 2027/0147; G02B 2027/0118

(57) ABSTRACT

The specification describes an enhanced reality visual interface in the form of smart eyeglasses that view, process, and project desired visual information to a user's field of view. High resolution picture elements or super-pixels are used to create an enhanced image for a user, based on the user's actual visual acuity and the desired enhanced image. Generated signals are delivered to the eye in a manner that image processing is carried out by the user's brain.

### CROSS REFERENCE

The present specification relies on, for priority, U.S. Patent Provisional Application No. 62/232,244, entitled “Methods and Devices for Providing Normal or Enhanced Visual Acuity”, filed on Sep. 24, 2015 and U.S. Patent Provisional Application No. 62/248,363, entitled “Methods and Devices for Providing Normal or Enhanced Visual Acuity”, filed on Oct. 30, 2015. The above-mentioned applications are herein incorporated by reference in their entirety.

### FIELD

The present specification is related generally to visual interfaces delivered through wearable devices, and particularly to a wearable device that augments a person's vision using high resolution picture elements.

### BACKGROUND

Vision begins when light rays are reflected off an object and enter the eyes through the cornea, the transparent outer covering of the eye. The cornea bends or refracts the rays that pass through a round hole called the pupil. The iris, or colored portion of the eye that surrounds the pupil, opens and closes (making the pupil bigger or smaller) to regulate the amount of light passing through. The light rays then pass through the lens, which actually changes shape so it can further bend the rays and focus them on the retina at the back of the eye.

The retina is a thin layer of tissue at the back of the eye that contains millions of tiny light-sensing nerve cells called rods and cones, which are named for their distinct shapes. Cones are concentrated in the center of the retina, in an area called the macula. In bright light conditions, cones provide clear, sharp central vision and detect colors and fine details. The fovea centralis is a small, central pit composed of closely packed cones in the eye. It is located in the center of the macula lutea of the retina. The fovea is the pit on the retina that collects light from the central two percent of the field of view.

The fovea is responsible for sharp central vision (also called foveal vision), which is necessary in humans for activities where visual detail is of primary importance, such as reading and driving. The fovea is surrounded by the parafovea belt, and the perifovea outer region. The parafovea is the intermediate belt, where the ganglion cell layer is composed of more than five rows of cells, as well as the highest density of cones; the perifovea is the outermost region where the ganglion cell layer contains two to four rows of cells, and is where visual acuity is below the optimum. The perifovea contains an even more diminished density of cones, having 12 per 100 micrometers versus 50 per 100 micrometers in the most central fovea. This, in turn, is surrounded by a larger peripheral area that delivers highly compressed information of low resolution following the pattern of compression in foveated imaging. Approximately half of the nerve fibers in the optic nerve carry information from the fovea, while the remaining half carries information from the rest of the retina. Rods are located outside the macula and extend all the way to the outer edge of the retina. They provide peripheral or side vision. Rods also allow the eyes to detect motion and help us see in dim light and at night. The cells in the retina convert the light into electrical impulses. The optic nerve sends these impulses to the brain where an image is produced.

Visual acuity is acuteness or clearness of vision. The term “20/20” vision is used to express normal visual acuity (the clarity or sharpness of vision) measured at a distance of 20 feet. Visual acuity depends on both optical and neural factors, such as (i) the sharpness of the retinal focus within the eye, (ii) retinal structure and functionality, and (iii) the sensitivity of the interpretative faculty of the brain.

A common cause of low visual acuity is refractive error (ametropia), or errors in how the light is refracted in the eyeball. Causes of refractive errors include aberrations in the shape of the eyeball, the shape of the cornea, and reduced flexibility of the lens. In the case of pseudo myopia, the aberrations are caused by muscle spasms. Too high or too low refractive error (in relation to the length of the eyeball) is the cause of nearsightedness (myopia) or farsightedness (hyperopia) (normal refractive status is referred to as emmetropia). Other optical causes are astigmatism or more complex corneal irregularities. These anomalies can mostly be corrected by optical means (such as eyeglasses, contact lenses, laser surgery, etc.).

Neural factors that limit acuity are located in the retina (such as with a detached retina or macular degeneration) or the brain (or the pathway leading there, such as with amblyopia). In some cases, low visual acuity is caused by brain damage, such as from traumatic brain injury or stroke.

Visual acuity is typically measured while fixating, i.e. as a measure of central (or foveal) vision, for the reason that it is highest there. However, acuity in peripheral vision can be of equal (or sometimes higher) importance in everyday life. Acuity declines towards the periphery in an inverse-linear (i.e. hyperbolic) fashion.

The eye is not a single frame snapshot camera, but rather more like a video stream where multiple individual snapshots of images are sent to the brain for processing into complete visual images. The human brain combines the signals from two eyes to increase the resolution further. These individual snapshots are, however, limited in their data content, and most of the signal processing is conducted by the brain to assemble and deliver meaningful normal vision. Certain data is deleted (scrubbed) by the brain (e.g. a person's nose which is always in the field of vision) and other parts of the images are enhanced (or “filled in”) so that a complete picture is developed and perceived by the brain. Problems occur when the eyes are unable to perceive and process vision in a normal manner.

Optimal color vision at normal visual acuity is only possible within that limited foveal vision area. It has been calculated that the equivalent of only 7 megapixels of data packed into the 2 degrees of acuity that the fovea covers during a fixed stare are needed to be rendered undetectable. It has been further estimated that the rest of the field of view requires 1 megapixel of more information.

The eye, in combination with the brain, assembles a higher resolution image than possible with the number of photoreceptors in the retina alone. The megapixel equivalent numbers below refer to the spatial detail in an image that would be required to show what the human eye could see when one views a scene:

90 degrees*60 arc-minutes/degree*1/0.3*90*60*1/0.3=324,000,000 pixels (324 megapixels).

For a 120 degrees field of view:

120*120*60*60/(0.3*0.3)=576 megapixels.

Thus, there are approximately 576 megapixels of picture elements that can be captured by the eyes with normal visual acuity and processed by the brain. Moreover, the eye also processes other visual cues such as light, distance/depth, color (through light/spectral capture), contrast and temperature. All of this visual data is transferred from the eye to the brain through visual signal processing (“VSP”).

The concept of using glasses to enhance one's vision is well-known to those of ordinary skill in the art. There are many conventional examples in the prior art of overlaying information on glasses being worn by a person. Thus, for example if a person is looking through glasses and is possibly interested in an object in the distance, vision enhancement device (such as glasses) worn by the person track his or her eye movements. The device determines if the user is looking at a particular object, captures that image using a camera, looks up information based on that captured image, and then overlays that information in the glasses worn by the user. Thus, a person looking at an object immediately learns that the object is, for example, an antique vase via a visual overlay. Exemplary prior art eye tracking methods are discussed in U.S. Pat. Nos. 5,583,795, 5,649,061, 6,120,461, 8,379,918, 8,824,779 and 9,070,017, which are also described in greater detail below.

To date, traditional and electronic display technologies, some of which are described below, have been insufficient to address the issue of restoring normal or better visual acuity. Most of the prior art attempts to deliver visual enhancement features, including virtual reality or 3D images in visual headgear provide for full focus of the entire field of view. Since neither the eye nor the brain process a single image at full potential resolution, the visual experience with existing technologies is severely lacking and can cause nausea and uneasiness through vergence-accommodation conflict. The latter involves distortions in perceived 3D structure compared with the percepts of the real scenes the displays depict. A likely cause of such distortions is the fact that existing displays present images on one surface. Thus, focus cues—accommodation and blur in the retinal image—specify the depth of the display rather than the depths in the depicted scene. This reduces one's ability to fuse the binocular stimulus and causes discomfort and fatigue for the viewer.

Thus, present technologies, such as High definition and Ultra High Definitive displays, three dimensional displays, holographic displays, virtual reality displays and augmented reality displays are limited by several physiological, ophthalmologic and visual processing issues, as they function to deliver unnatural and complete-focused images to the brain (complete data image snapshot) in a method different from the way that the brain itself processes these images in normal vision which sends multiple incomplete visual snapshots for the brain to process. Further, present methods of visual enhancement also have large data bandwidth processing constraints.

There is therefore a need for advanced display technologies that serve as a feedback loop that begins with determining the state or condition of the eye through testing, gathering data signals in a field of view, processing these data signals to provide a corrected and enhanced set of visual signals, and sending those visual signals back to the brain thereby altering what a person “sees”.

Thus, there is a need for improved methods for the manipulation and enhancement of visual elements that are perceived by the eye and processed by the brain. Devices based on such methods would avoid the problems associated with vergence-accommodation conflicts that can cause nausea and unease to many users. There is also a need for methods and systems that have low bandwidth requirements, besides providing a natural enhanced super-vision experience.

### SUMMARY

In some embodiments, the present specification discloses a vision enhancement device for providing enhanced visual acuity, comprising: a frame; at least one transparent substrate positioned within said frame; at least one digital camera positioned on said frame to capture a field of view; at least one sensor positioned on said frame for tracking eye movements; a processor and non-transient memory configured to store and execute a plurality of instructions, wherein, when said plurality of instructions are executed, said processor: receives and processes data from the at least one digital camera and at least one sensor to determine characteristics of a user's eyes; based on said characteristics, executes a perception engine to determine a minimum set of pixel data; generates collimated light beams in accordance with said minimum set of pixel data; and delivers the minimum set of pixel data to the user's eyes; and at least one energy source in electrical communication with said digital camera, said sensor, and said processor.

Optionally, at least a portion of said collimated light beams are directed toward specific individual photoreceptors in the user's eyes.

Optionally, at least a portion of said collimated light beams are directed toward specific individual photoreceptors in the user's eyes using at least one of an optical waveguide, a planar lens, and a reflector.

Optionally, said minimum set of pixel data comprises a minimum amount of pixel data required to project a desired image to a user.

Optionally, the vision enhancement device further comprises a display with sufficient resolution to project the enhanced visual picture elements onto at least one of a planar display of smart eyeglasses or onto the user's eye itself.

Optionally, the characteristics of the user's eyes comprise foveal and peripheral fields of focus.

Optionally, the vision enhancement further comprises at least one of a micro LED display, a quantum LED display and a pico-projection display device positioned on said frame.

Optionally, said minimum set of pixel data comprises a minimum amount of pixel data required to be provided to a fovea of the user to correct visual distortions caused by eye abnormalities and for enhancing a visual acuity of the user.

Optionally, the vision enhancement device further comprises a video capture device, wherein said video capture device captures video corresponding to the user's field of view.

Optionally, the processor is configured to time sync the characteristics of user's eyes with said captured video to determine the user's areas of interest and to generate time stamped video. Optionally, the processor is further configured to retrieve said time stamped video. Still optionally, the processor is further configured to translate coordinates from the user's field of view to the retrieved time stamped video. Still optionally, the processor is further configured to retrieve and display pixels in proximity to the translated coordinates in the field of view.

Optionally, the processor allows the user to make a real-time video capture of their visual field public, and share with a defined group of friends or post on an existing social network.

Optionally, the vision enhancement device further comprises a slider for zoom functionality.

Optionally, the vision enhancement device further comprises infra-red sensors to afford seeing through certain objects.

Optionally, the at least one digital camera captures a field of view ranging from zero to 360 degrees.

Optionally, the function of delivering the minimum set of pixel data to the user's eyes is carried out by means of at least one of eyeglasses or contact lenses.

Optionally, the minimum set of pixel data comprises image enhancement data including at least one of darkening, lightning, correction, or contrast enhancement.

Optionally, the minimum set of pixel data comprises data for image identification, targeting or discrimination.

In some embodiments, the present specification discloses a method of providing enhanced visual acuity to a user by mapping a visual field of the user to a video field, wherein video corresponding to, and capturing, said video field is stored in a non-transient memory and wherein a coordinate system defining said video field overlaps with a coordinate system defining said visual field, the method comprising: tracking a movement of an eye of the user to identify one or more locations in said visual field, wherein said one or more locations correspond with an area of interest to the user; using a camera to capture said video; synchronizing a timing of identifying said one or more locations with a timing of said video to generate time stamped video, wherein said time stamped video comprises said video and a time stamp of when said one or more locations were identified; retrieving the time stamped video; determining coordinates of said one or more locations within the coordinate system defining said visual field; translating the coordinates of said one or more locations from user's visual field to the coordinate system of the video field to yield video field coordinates defining a plurality of objects of interest in the video field; and based on said video field coordinates, applying a perception engine to said video to generate a modified video, wherein said perception engine visually highlights pixels that fall within said video field coordinates relative to pixels that are external to said video field coordinates, thereby visually highlighting said plurality of objects of interest.

Optionally, the perception engine comprises a software module executing block processing and edge processing techniques to remove pixels external to said video field coordinates.

Optionally, the perception engine comprises a software module executing a plurality of instructions to increase at least one of a contrast, color, brightness, luminance, or hue of the pixels that fall within said video field coordinates relative to the pixels that are external to said video field coordinates.

Optionally, the perception engine comprises a software module executing a plurality of instructions to decrease at least one of a contrast, color, brightness, luminance, or hue of the pixels that are external to said video field coordinates relative to the pixels that are within said video field coordinates.

Optionally, capturing the video of the user's visual field further comprises using at least one camera in conjunction with a video chip platform.

Optionally, tracking the eye of a user generates coordinate data defining said coordinate system for the user's visual field.

Optionally, the coordinates in the coordinate system of the user's visual field and the time stamp video data are used to identify frames in the video matching the user's visual field.

Optionally, the method of providing enhanced visual acuity to a user by mapping a visual field of the user to a video field is achieved by using a vision enhancement device comprising a digital camera to capture the video field of view, a sensor for tracking eye movements, a processor and non-transient memory configured to store and execute a plurality of instructions, an energy source in electrical communication with said digital camera, and a planar display.

Optionally, the vision enhancement device further includes wireless transceivers and is configured to transmit and receive data from wireless networks.

Optionally, the vision enhancement device is used to connect to a remote wireless network and to retrieve information about an object of interest corresponding with the plurality of objects of interest in the video field.

Optionally, the vision enhancement device is used to connect to the Internet and to share said modified video.

Optionally, the method of providing enhanced visual acuity to a user by mapping a visual field of the user to a video field further comprises displaying said modified video on a display and providing user controls for said display, wherein the user controls include pan, zoom, rewind, pause, play, and forward.

In some embodiments, the present specification discloses a method for providing enhanced visual acuity via a dynamic closed loop transfer/feedback protocol, comprising: determining the state or condition of a user's eye through testing; gathering information and data in the user's field of view; generating signals from said information and data; processing said data signals to provide a corrected set of visual signals; and, sending the visual signals to a user's brain.

In some embodiments, the present specification discloses a method for providing enhanced visual acuity, comprising the steps of: measuring and mapping at least one eye of a user; gathering information and data in a user's field of view; generating signals from said information and data; processing/translating said signals into high resolution picture elements; and transmitting said processed signals to the user's eye, wherein the user's brain processes said high resolution picture elements.

Optionally, said step of measuring and mapping is performed by at least one device.

Optionally, said step of measuring and mapping is performed manually.

Optionally, said step of eye mapping and testing is used to determine a user's specific eye anatomical conditions and digital image correction required.

Optionally, the steps of gathering information and generating signals are performed by a perception engine.

Optionally, said generated signals are a product of visual signal processing such that vision correction is specific to a user's individual requirements.

Optionally, said translated signals further comprise targeted pixels to provide enhanced information for the brain to process a normal or enhanced image. Still optionally, said translated signals further comprise targeted pixels to provide enhanced information for foveal and peripheral vision. Optionally, said targeted pixels are provided to the fovea for correcting visual distortions caused by eye abnormalities and for enhancing visual acuity beyond normal.

Optionally, the step of transmitting said processed signals to the user's eye is carried out by means of eyeglasses. Still optionally, the step of transmitting said processed signals to the user's eye is carried out by means of contact lenses.

In some embodiments, the eyeglasses may further comprise: at least one digital camera to capture a field of view; at least one camera/sensor for tracking eye movements; a display; a microprocessor to process the information received from the digital sensors and to deliver the enhanced visual picture elements, wherein said microprocessor may include a memory; a planar lens, waveguide, reflector or other optical device to distribute the processed super pixels to the eye; a battery or other power source with charging capabilities to drive the power requirements of the components; and optionally, zoom functionality with a slider or other control on the eyeglasses.

In some embodiments, the step of transmitting said processed signals to the user's eye may further comprise: time syncing eye tracking and video capture data to determine the user's area of interest; retrieving the corresponding time stamped video; translating the coordinates from user's visual field to the retrieved video field; retrieving and displaying selected/targeted pixels in proximity to the translated coordinates in the video field; and providing the user with controls for the display.

Optionally, said step of processing/translating said signals into high resolution picture elements comprises image enhancement such as darkening, lighting, correction, contrast enhancement, etc.

Optionally, said step of processing/translating said signals into high resolution picture elements comprises image identification, targeting or discrimination. Still optionally, said image identification, targeting or discrimination further comprises hazard identification in images.

In some embodiments, the present specification discloses a system for providing enhanced visual acuity, comprising: a perception engine; and smart eyeglasses/contact lenses, wherein said smart eyeglasses/contact lenses further comprise: at least one digital camera to capture a field of view; at least one camera/sensor for tracking eye movements; a semiconductor display with sufficient resolution to project the enhanced visual picture elements onto a planar display of the smart eyeglasses or the eye itself; a microprocessor to process the information received from the digital sensors and to deliver the enhanced visual picture elements; a planar lens, waveguide, reflector or other optical device to distribute the enhanced visual picture elements to the eye; a suitable memory; and a battery or other power source and charging capabilities to drive the power requirements of the components of the system.

Optionally, the smart eyeglasses further comprise a slider for zoom functionality.

Optionally, the smart eyeglasses further comprise infra-red sensors to afford seeing through certain objects.

Optionally, said camera to capture a field of view operates in a range of zero to 360 degrees, and preferably 180 to 360 degrees.

Optionally, said camera for tracking eye movements is used to determine the fovea and peripheral fields of focus.

Optionally, said display is a micro LED, quantum LED or other pico-projection display device.

In some embodiments, the present specification discloses a method for using a visual interface, comprising: tracking the eyes of a user to determine the user's area of interest; capturing the video of the user's visual field; mapping the user's visual field to the captured video field; displaying the identified captured video field; and enabling the user to control the display.

Optionally, the step of tracking the eyes of a user further comprises at least one eye tracking technology as described in the specification.

Optionally, the step of capturing the video of the user's visual field further comprises at least one video/chip platform.

Optionally, the step of mapping the user's visual field to the captured video field further comprises: time syncing eye tracking and video capture data to determine the user's area of interest; retrieving the corresponding time stamped video; translating the coordinates from user's visual field to the retrieved video field; retrieving and displaying pixels in proximity to the translated coordinates in the video field; and providing the user with controls for the display.

Optionally, the methods of the present specification may further comprise the step of visual field sharing in wherein users can make a real-time video capture of their visual filed public, and share with a defined group of friends or post on an existing social network.

The aforementioned and other embodiments of the present shall be described in greater depth in the drawings and detailed description provided below.

### BRIEF DESCRIPTION OF THE DRAWINGS

These and other features and advantages of the present specification will be further appreciated, as they become better understood by reference to the detailed description when considered in connection with the accompanying drawings:

FIG. 1 illustrates overall function of the present system based on dynamic closed-loop data transfer protocol, according to one embodiment;

FIG. 2 illustrates one embodiment of the enhanced reality visual interface in the form of smart eyeglasses;

FIG. 2a illustrates one embodiment of a frame of the smart eyeglasses;

FIG. 3 is a flowchart illustrating the overall function of the present system, according to one embodiment;

FIG. 4 is a flowchart illustrating a method of mapping a captured video field to a user's visual field, according to one embodiment;

FIG. 5 illustrates an embodiment of the smart eyeglasses, where identified captured video field is projected directly on to the user's eye;

FIG. 6 illustrates another embodiment of the smart eyeglasses, where identified captured video field is projected on the lens panel of the eyeglasses;

FIG. 7 is an illustration of one embodiment of a waveguide that may be used with the smart eyeglasses of the present specification;

FIG. 8 is a cross-sectional view of a waveguide depicting nine channels;

FIG. 9 is an illustration of various embodiments of waveguides that may be used with the smart eyeglasses of the present specification; and,

FIG. 10 is a cross-sectional view of a waveguide depicting sixteen channels, according to one embodiment of the present specification.

### DETAILED DESCRIPTION

In one embodiment, the method of present specification seeks to overcome the shortcoming of state of the art technologies utilized to correct vision, and to provide an enhanced “actual reality” viewing experience that will provide normal or better visual acuity. The “enhanced” or better than normal visual acuity viewing experience is capable of providing higher resolutions, zoom functionality, lighting enhancements, object identification, view or identification of objects at greater distance, and other enhancements.

In one embodiment, the present specification describes a vision enhancement protocol/technique that is both passive in its delivery of enhanced visual information to the user and active in its responsiveness to the user's response to the visual scene's integration with the additional delivered visual information, as it provides an enhanced visual stream of data for the brain to process as normal or enhanced “super-vision” by sending a directed stream of visual data at extremely high resolution to the eye. Thus, certain calculations and projections in the system of present specification are made passively in the background, while others are made based on active sensing of the eyes. Rather than merely eye tracking, the present system in one embodiment performs an active analysis of the user's neuro-bio processing based on eye measurements. In one embodiment, the present method allows for a new type of visual signal processing (VSP) for the brain to process an enhanced vision experience.

As known in the art, the eye is designed to perceive various elements of data in the form of visual “snapshots” and to send these images to the brain for processing. The data provided by the eyes to the brain is vast and allows the brain to process the data into what we understand as vision.

The core of the present specification involves understanding how a specific individual sees and providing a corrected and enhanced set of visual signals.

Vision involves the eye perceiving visual data and cues which are then processed by the brain. The data perceived by the eye is vast, but can be broken down into component data fields. These data fields can then be captured, processed, enhanced and transmitted to the eye to afford for normal or better than normal visual acuity. The present specification describes analyzing the eye and assembling a “Visual Field Data Matrix” (VFDM) including, but not limited to, extremely high resolution individual projected picture elements (pixels), telemetry data, distance and depth data, location data, color data, and temperature data, among others. As opposed to corrected images provided by passive and invasive ophthalmologic procedures and complete focused digital images provided by state of the art display and projection technologies, the Visual Field Data Matrix in the form of targeted “super-pixels” can be processed by the brain to create realistic enhanced vision in the manner the brain normally processes information.

In one embodiment, the extremely high resolution picture elements (“super-pixels”) are used to create and process an enhanced image for a user, based on the user's actual visual acuity and the desired enhanced image. Further, the present methods allow generated signals to be delivered to the eye in a manner that image processing is carried out by the brain. The present specification describes a self-contained real-time moving image capture, processing and image-generating device that is targeted for specific visual enhancements—these enhancements will be processed based on the visual requirements of the specific user.

In one embodiment, super-pixels are defined as those pixels in the video field which the system has mapped (from eye tracking in the visual field) and further processed, enhanced (processing for visual abnormalities, edge/block processing to determine what it is, zooming, etc.) for subsequent presentation to a user as high resolution picture elements.

In one embodiment, “super-vision” refers to being able to not just recognize objects in a visual field and overlay that visual field with information but fundamentally change what a person sees by capturing a video field in real-time and processing it in a manner that accounts for the user's eye movements and visual abnormalities, thereby creating “super vision”.

In one embodiment, the system of present specification is based on recent developments in the technology industry including smaller, faster and more economical microprocessors, smaller micro-display and projection technologies which allow for the manipulation of single pixels, wave-guide optics, and enhanced battery technologies.

In one embodiment, the methods of present specification provide advancements in the way that brain processes visual information provided by the eyes. The eyes are limited in their ability to provide visual images to the brain by numerous factors including vision abnormalities, lighting, distance, atmospheric conditions, etc. The present specification enhances the eye's ability to see and the brain's ability to process data by providing a more complete picture of the visual information available in the field of view to allow the brain to process super images. This is in contrast to merely providing a user with a complete image display as other prior art indicates. In one embodiment, the visual acuity provided by the present methods ranges from normal visual acuity to enhanced “super-vision”, based on the user's specific eye anatomy and condition and desired image quality.

By capturing a video field as a person looks around, one can process that video field in a way to make up for visual abnormalities and then present that processed video field so a person with that visual abnormality sees “normally”. For example, suppose a person has a vision problem causing the visual field to be very dark or dim. When capturing the video field, it can be processed to boost the lighting/brightness so that, when presented back to the viewer, it looks normal. In that way, the visual abnormality (dimness) is accounted for (by brightening the visual field). Thus, the method of the present specification may compensate for vision abnormalities including, but not limited to a) corneal, lens, and vitreous media opacification; b) retinal ischemia, trauma and/or degeneration including but not limited to age-related macular degeneration and hereditary disorders of the photoreceptors and retinal pigment epithelium; and c) optic nerve ischemia, trauma and/or degeneration including but not limited to glaucoma and other optic neuropathies by processing the video field to increase or decrease sharpness, brightness, hue, color, zoom, luminance, contrast, black level, white level, etc.”

In one embodiment, the system of present specification comprises “smart eyeglasses” that view, process, and project desired visual (and other) information to a user's field of view. In one embodiment, “smart eyeglasses” or “smart contact lenses” are used to leverage optical, digital and signal collection and processing to afford visually impaired people to have normal visual acuity, and even affording better than normal visual acuity if desired. These smart eyeglasses (or lenses) can be used as an alternative to traditional vision correction methods, and as enhanced augmented reality devices that will provide more realistic viewing of natural and generated images.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

It should be noted herein that any feature or component described in association with a specific embodiment may be used and implemented with any other embodiment unless clearly indicated otherwise. In addition, one of ordinary skill in the art would appreciate that the features described in the present specification can operate on any computing platform including, but not limited to: a laptop or tablet computer; personal computer; personal data assistant; cell phone; server; embedded processor; digital signal processor (DSP) chip or specialized imaging device capable of executing programmatic instructions or code.

It should further be appreciated that the platform provides the functions described in the present application by executing a plurality of programmatic instructions, which are stored in one or more non-volatile memories, using one or more processors and transmits and/or receives data through transceivers in data communication with one or more wired or wireless networks.

It should further be appreciated that each device has wireless and wired receivers and transmitters capable of sending and transmitting data, at least one processor capable of processing programmatic instructions, memory capable of storing programmatic instructions, and software comprised of a plurality of programmatic instructions for performing the processes described herein. Additionally, the programmatic code can be compiled (either pre-compiled or compiled “just-in-time”) into a single application executing on a single computer, or distributed among several different computers operating locally or remotely to each other.

In some embodiments, the present specification discloses advanced display technologies that serve as a feedback loop that begins with determining the state or condition of the eye through testing, gathering data signals in a field of view, processing these data signals to provide a corrected and enhanced set of visual signals, and sending those visual signals back to the brain thereby altering what a person “sees”. In some embodiments, the enhancements can be made regardless of the anatomical status of the person's eye, because the methods described herein seek to correct the signal and not the anatomy. Therefore, the present specification employs methods and devices that manipulate and enhance visual elements that are perceived by the eye and processed by the brain.

In one embodiment, the present vision enhancement protocol/technique involves multiple stages. In an embodiment, the present specification describes an eye testing and mapping protocol stage in which vision tests are used to determine the specific physical characteristics of the tested eye and its ability to process images in the field of view. Vision enhancement calculations are then performed, which involve analysis of the specific eye characteristics to determine the corrections required. Once the vision enhancement calculations are performed, visual signal processing (VSP) and projection of super-pixels onto the eye or onto the visual field for vision correction and/or enhancement occurs, using vision correction and enhancement software to deliver enhanced visual data (dubbed “super-pixels”) to the eye that overcomes tested abnormalities and provides vision correction and enhancement. The software uses visual data collection and processing techniques which correlate to providing the user with optimal desired visual acuity. The desired visual activity may be normal (for vision correction) or enhanced for other applications such as entertainment, professional work, or normal everyday living.

In one embodiment, enhanced reality smart eyeglasses are used to deliver the super-pixels to the eye. In one embodiment, certain eye examination tests may be conducted by the smart eyeglasses itself with the use of onboard sensors, processing and software.

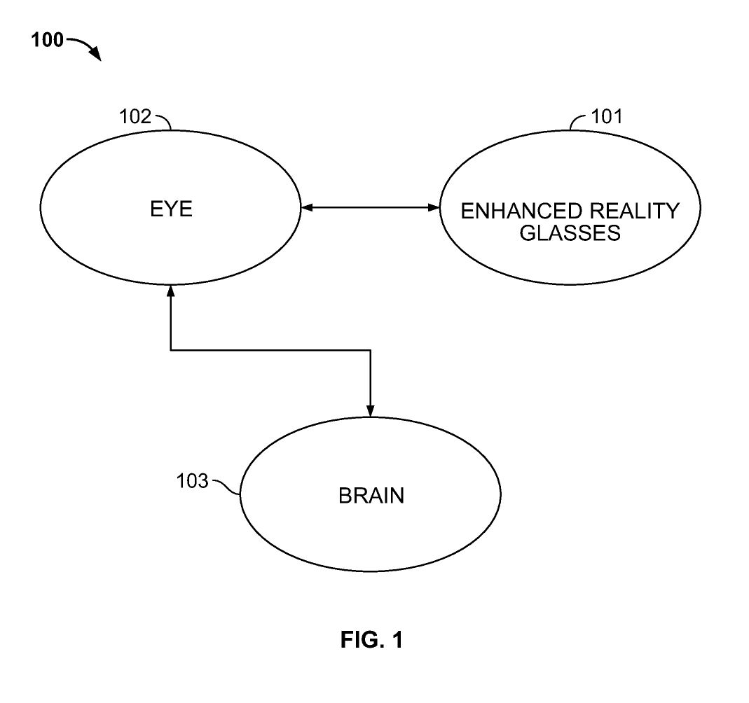

In one embodiment, the methods and devices of the present specification employ a dynamic closed-loop data transfer protocol. FIG. 1 illustrates overall function of the present system based on dynamic closed-loop data transfer protocol. Referring to FIG. 1, system 100 includes a pair of enhanced reality glasses 101 which act as a delivery device to deliver super images to the eye 102 of the user. The super images are processed by the brain 103, thereby allowing the user to see the images in accordance with desired acuity.

The feedback loop begins with determining the state of the eye 102, gathering data signals in a field of view, processing these data signals to provide a corrected and enhanced set of visual signals, and sending those visual signals back to the brain 103. It may be noted that all the steps mentioned above are carried out by the software and hardware associated with the enhanced reality eyeglasses 101, which are described in further detail in the later part of this document. There is real-time feedback from both the eyes in terms of visual requirements of the specific user and the data gathered in the field of view. The software associated with the present system then generates signals or instructions, translates them into high resolution picture elements (“super-pixels”) and sends back to the eye for the brain to process the super-enhanced image.

It may be appreciated that the feedback loop is a major distinction between the present system and the display and projection technologies in prior art. For example, a person may be presented with Ultra-HD photos and video, but if that person has defective eye anatomy, they will still see defective quality picture. The present system seeks to correct the signal and not the anatomy, thereby truly altering what a person sees.

The methods and devices of the present specification are intended to (a) provide a digital vision correction for a wide variety of vision abnormalities and (b) to afford enhanced vision capabilities (“super-vision”) such as enhanced night vision, zoom functionality, image identification, spatial-distance enhancement, resolution enhancement and other visual enhancements.

The present specification describes methods and wearable devices for delivering visual interfaces, and in particular, to a wearable device that augments a person's vision using high definition video. The present specification is implemented using at least three components: targeted eye testing and mapping; a perception engine with associated software and algorithms; and smart eyeglasses/contact lenses.

### I. Targeted Eye Testing and Mapping

In one embodiment, eye tests are conducted to determine how patient's eye perceives images in field of view. A first stage of testing may include digital mapping of the eye through the use of medical scanning devices. Physical characteristics and abnormalities of the tested eye are mapped in order to provide a complete anatomical map.

It may be noted that anatomical mapping of the eye may be carried out using any suitable technologies known in the art such as Corneal topography, also known as photo-keratoscopy or video-keratography, which is a non-invasive medical imaging technique for mapping the surface curvature of the cornea, the outer structure of the eye, and laser retina scans that are used to detect retinal abnormalities.

In one embodiment, a second stage of testing may be implemented and may include a visual field test. As known in the art, a visual field test is an eye examination that can detect dysfunction in central and peripheral vision which may be caused by various medical conditions such as glaucoma, stroke, brain tumors or other neurological deficits. In an embodiment, the vision field test may be a light field test (LFT) where extremely high resolution quantum pixels using, for example, a quantum LCD projection device are projected onto eye in order to further determine eye function and ability to perceive quantum pixels of light of different color, contrast and intensity at different fixed points of the eye as mapped out in the first stage of testing.

The results of the two tests provide the baseline visual processing characteristics of the tested eye into a Complete Digital Eye Map (CDEM). In one embodiment, the above eye testing is carried out by trained opticians. In another embodiment, eye testing is carried out automatically by the smart eyeglasses.

### II. Perception Engine Data Collection and Processing Algorithms and Software

The eye is the first part of an elaborate system that leads to “seeing”. Image processing begins in the retina of the eye, where nerve cells parse out the visual information in images featuring different content before transmitting them to the brain.

In an article entitled “Visual Image Reconstruction from Human Brain Activity using a Combination of Multiscale Local Image Decoders”, published in Neuron, 60, 915-929, Dec. 11, 2008, which is herein incorporated by reference, a reconstruction of visual images by combining local image bases of multiple scales, whose contrasts were independently decoded from fMRI activity by automatically selecting relevant voxels and exploiting their correlated patterns is described. Binary-contrast, 10×10-patch images (2100 possible states) were accurately reconstructed without any image prior on a single trial or volume basis by measuring brain activity only for several hundred random images. Reconstruction was also used to identify the presented image among millions of candidates. Their approach provides an effective means to read out complex perceptual states from brain activity while discovering information representation in multi-voxel patterns. The primary purpose of the article is to reconstruct visual images from brain activity and the article illustrates that contrast-defined arbitrary visual images can be reconstructed from fMRI signals of the human visual cortex.

The system of present specification bridges the gap between vision and perception by providing a refined perceptive experience, as opposed to mere 20/20 vision or 2D, 3D or holographic images; the methods described herein seek to correct the signal. In one embodiment, enhanced vision is based on pre-determined parameters and also on user desires.

In some embodiments, the pre-determined parameters include, but are not limited to user-specific video field adjustments (brightness, contrast, etc.) based on the user's specific vision characteristics. The user desires are how the user wants to interact with the glasses.

Once eye mapping and testing is complete, vision enhancement calculations are performed, which involve analysis of the user's specific eye characteristics and eye anomalies to determine the corrections required.

In one embodiment, the processing software comprises a Perception Engine which actively records, processes and converts the information in a user's field of view into visual signals (which are dubbed “super-pixels”) to allow for desired perception by the brain. In one embodiment, the Perception Engine drives specially designed smart wearable enhanced reality eyeglasses.

In one embodiment, data processing algorithms are applied to correlate multiple elements of data including CDEM, eye tracking, image capture and enhanced super-pixel projection to the eyes. In one embodiment, algorithms and software utilize the baseline CDEM and provide instructions to allow for the eye to perceive images with normal or better visual acuity. The software provides instructions for the control of individual quantum pixels to deliver specific enhanced visual data to the eye for processing by the brain.

Thus, once the vision enhancement calculations are performed, visual signal processing (VSP) and projection of super-pixels onto the eye or onto the visual field for vision correction and/or enhancement occurs. Vision correction and enhancement software is used to deliver enhanced visual data (termed “super-pixels”) to the eye that overcomes tested abnormalities and provides vision correction and enhancement. The software uses visual data collection and processing techniques which are correlated with information in the user's field of view to provide the user with optimal desired visual acuity. The desired visual activity may be normal (for vision correction) or enhanced for other applications such as entertainment, professional work, or normal everyday living.

### III. Enhanced Reality Smart Eyeglasses/Contact Lenses

In some embodiments, the present specification discloses the use of a visual interface, such as eyeglasses, that are capable of performing eye tracking functions, capturing video, mapping the visual field to the captured video field, displaying the identified captured video field to the user and enabling the user to control that display, and, finally, visual field sharing.

In some embodiments, the methods and devices of the present specification may use a high definition camera to capture a person's entire visual field in great detail. In some embodiments, the methods and devices of the present specification will employ eye tracking to determine where a person is looking and then map that location to a video field. Once mapped to the video field, it will retrieve that portion of the video field and allow a person to zoom in, pan around, and manipulate the resultant “enhanced” image accordingly. The resultant image is a fully enhanced depiction of a person's visual field by integrating high definition video (and therefore detail the person may not have actually seen) using a video camera that is of higher magnification than human eyesight. For example, the embodiment could use video cameras and/or other sensors that can resolve better than the theoretical limit of human vision, 0.4 minute-arc.

In one embodiment, the functionality of smart eyeglasses is integrated into contact lenses. In other embodiments, the same functionality is integrated into third party devices, including third party eye glasses, with the augmented reality (AR)/virtual reality (VR) processing being provided by the system of present specification.

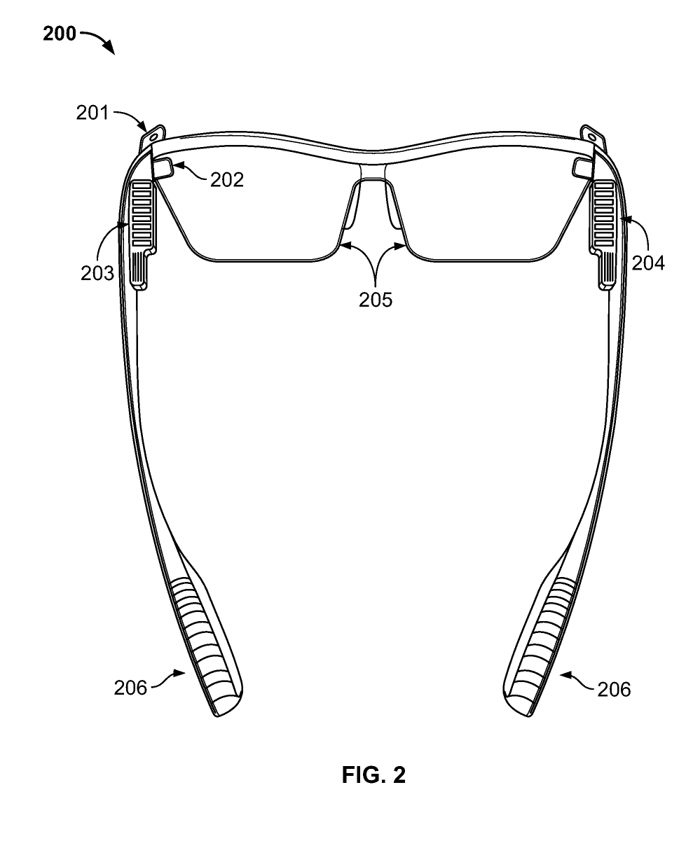

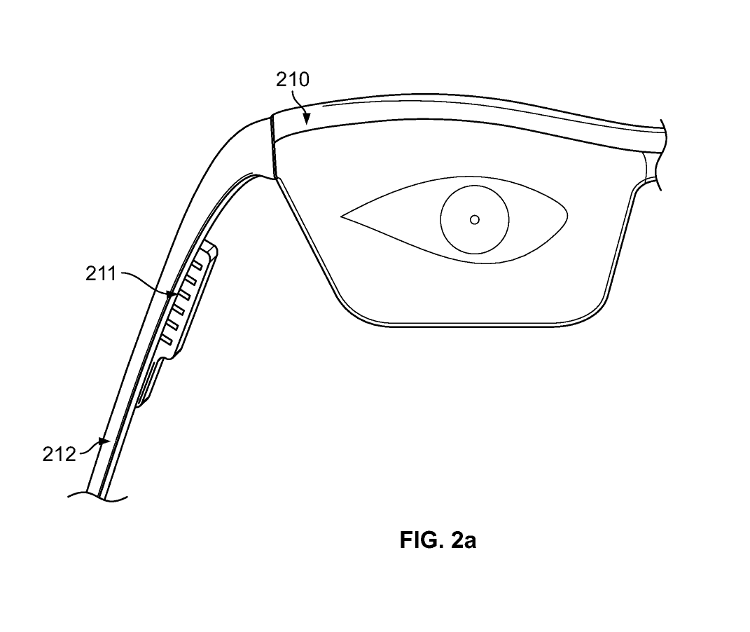

FIG. 2 illustrates an embodiment of the “enhanced reality” visual interface in the form of smart eyeglasses. Referring to FIG. 2, in one embodiment smart eyeglasses 200 comprise one or more digital cameras 201(A) or sensors to capture a field of view. In some embodiments, the system may employ one or more outward facing digital cameras or sensors. The field of view of these cameras may typically be 180 degrees, but may also be up to 360 degrees depending on application. It may be noted that digital cameras may be based on any suitable kind of imaging sensors, such as semiconductor charge-coupled devices (CCD) or active pixel sensors in complementary metal-oxide-semiconductor (CMOS) or N-type metal-oxide-semiconductor (NMOS, Live MOS) technologies. In one embodiment, digital cameras with night vision capabilities are employed. In one embodiment, digital cameras are equipped with infrared sensors.

The smart eyeglasses 200 further comprise cameras/sensors 202(B) for tracking eye movements. In some embodiments, the system may employ one or more inward facing digital cameras or sensors, which are used to track the movement of the eyes and to determine the foveal and peripheral fields of focus. This information helps to determine the object(s) that a user may be looking at. Exemplary systems and methods for eye tracking are discussed in greater detail below. The inward facing digital cameras or sensors may be based on any suitable kind of imaging sensors, such as semiconductor charge-coupled devices (CCD) or active pixel sensors in complementary metal-oxide-semiconductor (CMOS) or N-type metal-oxide-semiconductor (NMOS, Live MOS) technologies.

Smart eyeglasses 200 further comprise, in one embodiment, a display semiconductor or similar device 203(C) with sufficient resolution to project required super-pixels onto a planar display of the smart eyeglasses or the eye itself. In one embodiment, the system may employ a micro LED, quantum LED or other pico-projection display device with the ability to project or display sufficient digital information to either a heads up display (screen) on the planar field of the smart eyeglasses or via a direct projection of pixels onto the user's eye. It may be noted that pico-projection devices use an array of picoscopic light-emitting diodes as pixels for a video display, and hence are suited for smart eyeglasses application.

Still referring to FIG. 2, smart eyeglasses 200 comprise at least one microprocessor 204(D) to process the information received from the digital sensors and to deliver the enhanced visual picture elements (super-pixels) to a planar display on the eyeglass lens itself or to project directly onto the eye itself (through an optical or digital waveguide). In an embodiment, the system further comprises software for creating directed super-pixels.

The system also comprises a planar lens, waveguide, reflector or other optical device 205(E) to distribute the processed super-pixels to the eye. In one embodiment, the data set comprising super-pixels is tailored to different delivery devices or methods, such as planar lenses, direct to eye, and/or passive display. It may be noted that regardless of the projection method or device, the present system is able to manipulate the form of the super-pixels being delivered to the eye.

In one embodiment, the smart eyeglasses use an optical waveguide to direct the processed images. In another embodiment, the smart eyeglasses use a digital waveguide to direct the processed images towards the eye. Some embodiments of optical waveguides are described in greater detail below.

Smart eyeglasses 200 further comprise a battery or other power source 206(F) with charging capabilities to drive the power requirements of various components of the system. In one embodiment, the smart eyeglasses are equipped with nanobatteries, which are rechargeable batteries fabricated by employing technology at the nanoscale.

Optionally, smart eyeglasses 200 also comprise one or more non-volatile memories.

It may be appreciated that reducing the amount of information to be transmitted reduces processing power requirements, power requirements, memory/cache requirements and bandwidth requirements. Therefore in one embodiment, the information or data transmitted in the present system comprises necessary super pixel data set to drive enhanced imagery, as opposed to complete image generation data. Thus, in one embodiment, the non-volatile memory is used to store static parts of images while heavier computing is being performed for super-pixels to complete the image processing in the brain. The processing is similar to the way the brain decodes visual data in real life through neuro-bio mechanisms). In one embodiment, at least one or several microprocessors may optionally be placed individually or in an array within the glasses for automatically performing eye testing and mapping. FIG. 2a illustrates one embodiment of a frame 210 of the smart eyeglasses. Referring to FIG. 2a, in this embodiment, an array of microprocessors 211 is placed along one of the sides 212 of the frame. One of ordinary skill in the art would appreciate that the array of microprocessors may be placed at any other suitable location in the frame 210 of the smart eyeglasses. The microprocessors in the array 211 are used in one embodiment, for automatically performing eye testing and mapping. In one embodiment, the microprocessor to process information received from the digital sensors and to deliver the enhanced visual picture elements (super-pixels) to a planar display on the eyeglass lens or the eye (as shown as 204(D) of FIG. 2), is also placed in the same array 211, along with other microprocessors. In one embodiment, the microprocessors for eye testing and mapping and those for processing data from the sensors and delivering super-pixels are placed in separate location on the frame 210.

In one embodiment, a manual slider (not shown) for performing a zoom function is also provided on the frame of the smart eyeglasses.

It may be noted that the visual interface of the present specification transmits and/or receives data through transceivers in data communication with one or more wired or wireless networks.

Thus, the visual interface device has wireless and/or wired receivers and transmitters capable of sending and transmitting data, at least one processor capable of processing programmatic instructions, memory capable of storing programmatic instructions, and software comprised of a plurality of programmatic instructions for performing the processes described herein.

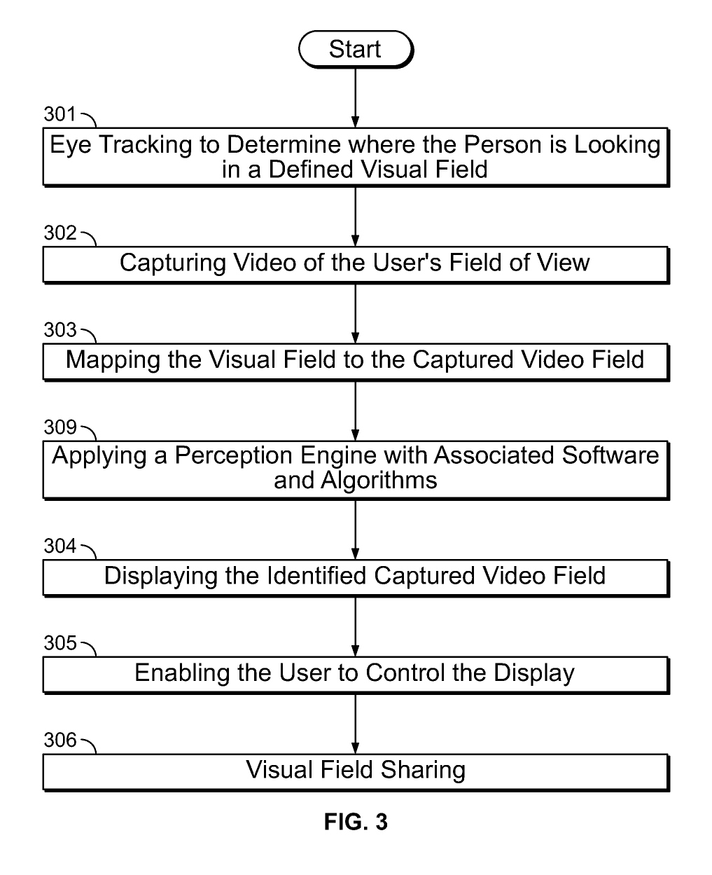

FIG. 3 is a flowchart illustrating the overall function of the system of the present specification that uses smart eyeglasses to deliver enhanced vision to a user. In one embodiment, these functions are carried out under the control of a microprocessor embedded in the smart eyeglasses, which executes instructions in accordance with appropriate software algorithms. Referring to FIG. 3, the first step 301 involves tracking the eye movement of the user wearing the smart eyeglasses. Eye tracking is used to determine the object(s) that the user is looking at in a defined visual field, and is carried out in one embodiment, using any suitable eye tracking technique available in the art.

The next step 302 is video capture, wherein digital cameras or sensors in the smart eyeglasses capture images of the user's field of view. Processing software and hardware then combine the images into a video.

Next the captured video field is mapped to the visual field of the user, as shown in step 303. This step ensures that the system displays the image or video of the same object or scene to the user, which the user appears to be interested in as determined by the eye tracking step.

After mapping, a perception engine is applied 309 and the identified captured video field is displayed to the user, as shown in step 304. As mentioned before, the mapped video may be displayed on a planar display on the lenses of the smart eyeglasses or may be projected directly to the eye itself.

In the next step 305, the user is enabled to control the display. Here, user is provided with controls to manipulate the display. These controls may include functions such as rewind, zoom, pan, etc.

Optionally, in another step 306 the user is enabled to share the visual field he or she is viewing with other individuals by means of social networks.

Also optionally, the smart eyeglasses are able to connect to the Internet, using the wireless transceivers integrated within the frame (as mentioned earlier with reference to FIG. 2), and retrieve information pertaining to a user's object of interest and display.

All the above steps are described in greater detail in the following sections.

a. Eye Tracking

Eye tracking methods are used to measure the point of gaze or the motion of an eye relative to the head. Devices that aid the process of eye tracking are called eye trackers. Such devices are used in research on the visual system, in psychology, in psycholinguistics, marketing, as an input device for human computer interaction, and in product design. Eye tracking devices use different methods for their purpose. Some of the commonly known methods attach an object (such as a contact lens) to the eye; use a non-contact optical technique to measure eye-movement; or measure electric potentials using electrodes placed around the eyes. Sometimes, methods for eye tracking are combined with methods for gaze-tracking, where the difference is typically in the position of the measuring system.

Most widely used methods that have commercial and research applications involve non-contact optical eye-tracking techniques. For example, video-based eye trackers use a camera that focuses on one or both eyes and records their movement as the viewer looks at some kind of stimulus. Most modern eye-trackers use the center of the pupil and infrared/near-infrared non-collimated light to create corneal reflections (CR). The vector between the pupil center and the corneal reflections can be used to compute the point of regard on surface or the gaze direction. Bright-pupil, dark-pupil, and passive-light techniques are based on infrared or active, and passive light, respectively. Their difference is based on the location of the illumination source with respect to the optics and the type of light used. Eye-tracking setups can be head-mounted, or require the head to be stable, or function remotely and automatically track the head during motion.

Examples of existing devices and techniques used for eye tracking include U.S. Pat. No. 5,583,795, assigned to the United States Army, which discloses an apparatus that can be used as an eye-tracker to control computerized machinery by ocular gaze point of regard and fixation duration. This parameter may be used to pre-select a display element causing it to be illuminated as feedback to the user. The user confirms the selection with a consent motor response or waits for the selection to time out. The ocular fixation dwell time tends to be longer for display element of interest. The patent also discloses methods that use an array of photo-transistor light sensors and amplifiers directed toward the cornea of the eye. The opto-transistor array, a comparator array and an encoder and latch clocked by the raster-scan pulses of the display driver, are used to construct a pairing table of sequential source corneal reflections to sensor activations over the display field refresh cycle. The pairing table listings of reflections is used to compute an accurate three dimensional ocular model which for each display field refresh cycle, locates the corneal center and optical axis as well as the corneal orientation from the major and minor axes. The visual origin and axis is then computed from these parameters.

U.S. Pat. No. 6,120,461 also assigned to the United States Army relates to the '795 patent and replaces the video display as a sequential source of light with a retinal scanning display. The retinal scanning display is used with an active-pixel image sensor array with integrated circuits, and an image processor to track the movements of the human eye.

U.S. Pat. No. 5,649,061, also assigned to the United States Army, discloses methods to estimate a mental decision to activate a task related function which is selected by a visual cue in order to control machines from a visual display by eye gaze. The method estimates a mental decision to select a visual cue of task related interest, from both eye fixation and the associated single event evoked cerebral potential. The start of the eye fixation is used to trigger the computation of the corresponding evoked cerebral potential. For this purpose an eye-tracker is used in combination with an electronic bio-signal processor and a digital computer. The eye-tracker determines the instantaneous pupil size and line-of-sight from oculometric measurements and a head position and orientation sensor.

U.S. Pat. No. 8,379,918, to Pfleger et al., use eye-tracking systems to measure perception, involving processing at least first visual coordinates of a first point of vision assigned to a first field-of-view image and determined by using an eye tracking system, processing at least second visual coordinates of a second point of vision assigned to a second field-of-view image, with the second field-of-view image being recorded after the first field-of-view image, examining the second visual coordinates of the second point of vision together with the first visual coordinates of the first point of vision in a comparison device and checking whether they fulfill at least one predetermined first fixation criterion, assigning the first and second points of vision, provided they fulfill the at least one first fixation criterion, to a first fixation assigned to an ordered perception, and marking the first and second points of vision as such, and assigning the first and second points of vision, if they do not fulfill the at least one first fixation criterion, to a first saccade, to be assigned to aleatoric perception, and marking the first and second points of vision as such. In the eye-tracking system, the visual field of the test subject is recorded using a first camera (76) rigidly connected to the head (80) of the test subject so that it faces forward and is recorded in a visual field video, the movement of the pupils of the test subject is recorded with a second camera (77), which is also rigidly connected to the head (80) of the test subject, and is recorded in an eye video, and the eye video and the visual field video (9) are recorded on a video system and time-synchronized, wherein for each individual image of the eye video, therefore for each eye image (78) the pupil coordinates xa,ya are determined, the correlation function K between pupil coordinates xa,ya on the eye video and coordinates xb,yb of the corresponding point of vision B, i.e. the point the test subject fixes on, on which the visual field image (79) of the visual field video (9) is determined, and after determining the correlation function K for each individual image from the pupil coordinates xa,ya on the eye video, the coordinates xb,yb of the corresponding point of vision B on the visual field video are extrapolated, wherein to determine the pupil coordinates xa,ya for each individual image of the eye video with a visual detection program, the contrasts of the pupils to the surroundings are automatically recorded, all points of the individual image, which are darker than a predefined degree of darkness, are identified, these points record and limit an area of darkness corresponding to the pupil and the focus of the area of darkness, which corresponds to the middle of the pupil with the pupil coordinates xa,ya, is determined.

U.S. Pat. No. 8,824,779, to Christopher C. Smyth, discloses a single lens stereo optics design with a stepped mirror system for tracking the eye, isolates landmark features in the separate images, locates the pupil in the eye, matches landmarks to a template centered on the pupil, mathematically traces refracted rays back from the matched image points through the cornea to the inner structure, and locates these structures from the intersection of the rays for the separate stereo views. Having located in this way structures of the eye in the coordinate system of the optical unit, the invention computes the optical axes and from that the line of sight and the torsion roll in vision.

U.S. Pat. No. 9,070,017, assigned to Mirametrix Inc., discloses a method for presenting a three-dimensional scene to the user; capturing image data which includes images of both eyes of the user using a single image capturing device, the image capturing device capturing image data from a single point of view having a single corresponding optical axis; estimating a first line-of-sight (LOS) vector in a three-dimensional coordinate system for a first of the user's eyes based on the image data captured by the single image capturing device; estimating a second LOS vector in the three-dimensional coordinate system for a second of the user's eyes based on the image data captured by the single image capturing device; determining the three-dimensional POG of the user in the scene in the three-dimensional coordinate system using the first and second LOS vectors as estimated based on the image data captured by the single image capturing device.

U.S. patent application Ser. No. 2015/0002392, filed by Applicant Umoove Services, Ltd, and incorporated herein by reference, discloses an eye tracking method including: in a frame of a series of acquired frames, estimating an expected size and expected location of an image of an iris of an eye within the frame; and determining a location of the iris image within the frame by identifying a region within the expected location, a size of the region being consistent with the expected size, wherein pixels of the region have luminance values darker than pixels of other regions within the expected location.

U.S. patent application Ser. No. 2015/0128075, filed by filed by Applicant Umoove Services, Ltd., and incorporated herein by reference, discloses a method for scrolling content that is displayed on an electronic display screen by tracking a direction or point of a gaze of a viewer of the displayed content, and when a gaze point in a plane of the display screen and corresponding to the tracked gaze direction is moved into predefined region in the plane of the display screen, automatically scrolling the displayed content on the display screen in a manner indicated by tracked gaze direction. The method uses an analysis of the image of a user, which is acquired by an imaging device like a camera, infra-red imager or detector, a video camera, a stereo camera arrangement, or any other imaging device capable of imaging the user's eyes or face. Analysis of the image may determine a position of the user's eyes, e.g., relative to the imaging device and relative to one or more other parts or features of the user's face, head, or body. A direction or point of gaze may be derived from analysis of the determined positions.

U.S. patent application Ser. No. 2015/0149956, filed by Applicant Umoove Services, Ltd. and incorporated herein by reference, discloses a method to track a motion of a body part, such as an eye, in a series of images captured by an imager that is associated with an electronic device, and detect in such motion a gesture of the body part that matches a pre-defined gesture. In an acquired image of said series of acquired images, an expected size and expected location of an image of an iris of an eye is estimated within that acquired image, and a location of the iris image is determined within that acquired image by identifying a region within the expected location, a size of the region being consistent with the expected size, wherein pixels of the region have luminance values darker than pixels of other regions within the expected location.

U.S. patent application Ser. No. 2015/0234457, filed by Applicant Umoove Services, Ltd., and incorporated herein by reference, discloses a system for content provision based on gaze analysis, the system comprising: a display screen to display a initial content item; a processor to perform gaze analysis on acquired image data of an eye of a viewer viewing the screen to extract a gaze pattern of the viewer with respect to one or a plurality of initial content items, and to cause a presentation of one or a plurality of supplementary content items to the viewer, based on one or a plurality of rules applied on the extracted gaze pattern. The described method allows using any technique for tracking eye gaze, including, for example, using an imaging sensor (e.g., camera) to acquire instantaneous image data (e.g., video steam, or stills) of the viewer's eye and an algorithm run by a processor to determine the instantaneous direction of the viewer's gaze with respect to the content shown on the screen. This may be implemented, for example, by analyzing the image data of the eye, and determining the position of the pupil of the eye with respect to the viewed eye.

PCT Publication No. WO 2014/192001, filed by Applicant Umoove Services, Ltd. and incorporated herein by reference, discloses methods and system for calibration of gaze tracking. The method includes displaying on an electronic screen being gazed by a user, a moving object during a time period; acquiring during the same time period images of an eye of a viewer of the screen; identifying a pattern of movements of the eye during that time period, where the pattern is indicative of viewing the moving object by the eye; and calibrating a gaze point of the eye during the time period with a position on the screen of the object during the time period.

All of the above-mentioned patents and patent applications are herein incorporated by reference as possible methods that may be implemented in the methods and devices disclosed by the present specification.

b. Video Capture

Outward facing digital cameras or sensors in the smart eyeglasses (as shown in FIG. 2) capture images of the user's field of view. It may be appreciated that the outfacing cameras provide a point of reference for what the eye and the body are positioned to experience, both visually and physically. Processing software and hardware then combine the images into a video. In an embodiment, a video of the user's visual field may be captured using at least one camera in conjunction with a video chip platform.

c. Mapping the Visual Field to the Captured Video Field

In an embodiment, tracking the eye of a user generates coordinate data that defines a coordinate system for the user's visual field. A captured video field is mapped to the visual field of the user, ensuring that the system displays the image or video of the same object or scene to the user, which the user appears to be interested in as determined by the eye tracking step. Each frame of the captured video field is time stamped. The user's view is eye-tracked and the moment when the user's gaze is determined to show an interest in something is time-stamped. The system uses the coordinates of the user's eye gaze and the time stamp to find the frame(s) in the video field matching that time stamp and then identifying the pixels matching the coordinates of the eye gaze. Once the pixels are identified, they are subjected to the video processing techniques described above to create super-pixels.

In the present system, the visual field of a user is captured in the form of a video field. Using eye tracking, the system maps where the person is looking in the visual field to the video field. In certain embodiments, where the system is used for applications such as precision manufacturing, repairs, surgery, and the like, eye tracking data may be supplemented by manually input data, controlled by the user.

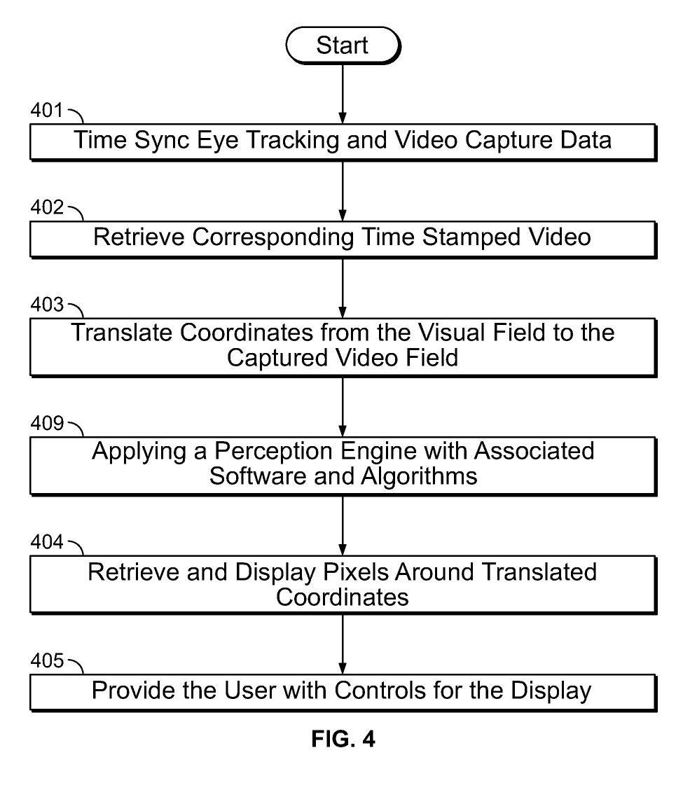

FIG. 4 is a flowchart illustrating a method of mapping a captured video field to a user's visual field, according to one embodiment. Referring to FIG. 4, in the first step 401 eye tracking data and video capture data are time synced. As mentioned above, eye tracking data marks where the person is looking in a defined visual field, wherein the size of the defined visual field is, for example, X×Y pixels. When eye tracking data indicates a person is interested in a particular object, the corresponding time stamped video is retrieved, as shown in step 402. The area or object of interest within the defined visual field may be denoted as X′×Y′ pixels. It may be noted that X′×Y′ is a smaller subset of pixels of the defined visual field, and could be as small as 100×100 pixels. Next in step 403, the coordinates of a person's eye focus are translated from the visual field to the captured video field. In this step, the system maps where the person is looking in the visual field to the video field. Accordingly, X′,Y′ in the visual field is translated to X″, Y″ in the video field. Thus, the coordinates of one or more locations from the user's visual field are translated to the coordinate system of the video field to yield video field coordinates defining at least one, and preferably a plurality of objects of interest in the video field. A perception engine is applied 409 and pixels in and around X″, Y″ are fetched and displayed, to show the user's area or object of interest in the video field, as shown in step 404. This step, via a software module in the perception engine, makes use of appropriate block processing and edge processing techniques, to remove unwanted pixels in the video field (those pixels that are external to the video field coordinates) and retrieve the pixels related only to the object and area of interest, thus generating a modified video. In an embodiment, the perception engine visually highlights pixels that fall within said video field coordinates relative to pixels that are external to the video field coordinates, thereby visually highlighting at least one object of interest, and preferably objects and areas of interest. In an embodiment, the perception engine includes a software module capable of executing a plurality of instructions to increase or decrease at least one of a contrast, color, brightness, luminance, or hue of the pixels that fall within the video field coordinates relative to the pixels that are external to the video field coordinates.

Thereafter, user is provided with controls to manipulate the display, as shown in 405. Exemplary controls for manipulating the display include, but are not limited to pan, zoom, rewind, pause, play, and forward.

In an embodiment, mapping a visual field of the user to a video field is achieved by using a vision enhancement device, such as but not limited to smart eyeglasses, as described throughout the specification, which comprises a digital camera to capture the video field of view, a sensor for tracking eye movements, a processor and non-transient memory configured to store and execute a plurality of instructions, an energy source in electrical communication with said digital camera, and a planar display.

As mentioned earlier, the smart eyeglasses are equipped with wireless transceivers and are capable of transmitting and receiving data from wireless networks. This allows them to connect to the Internet and retrieve information about the user's object of interest. In this context, it may be appreciated that the use of block processing and edge processing techniques to remove unwanted pixels in the video field and retrieve only the relevant pixels not only provides a user with enhanced vision of their object or area of interest, but also saves data bandwidth when fetching related information from the Internet or sharing the video field to social media.

It may be noted that the present system may rely on any of the existing edge detection and processing techniques available in the art. As known in the art, edge detection refers to a set of mathematical methods which aim at identifying points in a digital image at which the image brightness changes sharply or, more formally, has discontinuities. These mathematical methods may thus be used to analyze every pixel in an image in relation to the neighboring pixels and select areas of interest in a video field, while eliminating the non-relevant pixels.

In one embodiment, the system uses one or a combination of several approaches—including Canny edge detection, first-order methods, Thresholding and linking, Edge thinning, second-order approaches such as Differential edge detection and Phase congruency-based edge detection.

It may be appreciated that when working with large images, normal image processing techniques can sometimes break down. The images can either be too large to load into memory, or else they can be loaded into memory but then be too large to process.

To avoid these problems, in one embodiment, the present system processes large images incrementally (block processing). In block processing, images are read, processed, and finally written back to memory, one region at a time. As an example of a block processing function, the function divides the input image into blocks of the specified size, processes them using the function handle one block at a time, and then assembles the results into an output image.

In one embodiment, the image is divided into several discrete zones corresponding to eye movement, such as active movement, static and slow moving. These zones are then overlaid, for a complete image to be generated and delivered to the brain via augmented reality or virtual reality. In one embodiment, system memory is organized to optimize the kind of image processing employed.

In one embodiment, block processing is used in combination with edge detection methods, such as Canny edge detection, to achieve quick and efficient results in identifying an area or object of interest in the captured video field.

In video processing, edge detection is often used to identify whether a pixel value being estimated lies along an edge in the content of the frame, and interpolate for the pixel value accordingly. In the ideal case, the result of applying an edge detector to an image may lead to a set of connected curves that indicate the boundaries of objects, the boundaries of surface markings as well as curves that correspond to discontinuities in surface orientation. Thus, applying an edge detection algorithm to an image may significantly reduce the amount of data to be processed and may therefore filter out information that may be regarded as less relevant, while preserving the important structural properties of an image. If the edge detection step is successful, the subsequent task of interpreting the information contents in the original image may therefore be substantially simplified. However, it is not always possible to obtain such ideal edges from real life images of moderate complexity.

Edges extracted from non-trivial images are often hampered by fragmentation, meaning that the edge curves are not connected, missing edge segments as well as false edges not corresponding to interesting phenomena in the image—thus complicating the subsequent task of interpreting the image data.

In one method, the potential edge and its angle are determined based on filtering of offset or overlapping sets of lines from a pixel field centered around the pixel being estimated. The filter results are then cross-correlated. The highest value in the correlation result values represents a potential edge in proximity to the pixel being estimated. This information is used in conjunction with analysis of the differences between pixels in proximity to verify the existence of the potential edge. If determined to be valid, an interpolation based on the edge and its angle is used to estimate the pixel value of the pixel.

d. Displaying the Identified Captured Video Field

After mapping, the identified captured video field is displayed to the user. As mentioned earlier, the mapped video may be displayed on the panel of the smart eyeglasses or may be projected directly to the eye itself. FIG. 5 illustrates an embodiment of the smart eyeglasses, where identified captured video field is projected directly on to the user's eye. Referring to FIG. 5, smart eyeglasses 501 comprise a projector or a microprocessor 502, capable of processing a high definition video or enhanced visual picture elements, based on the information received from the digital sensors. The eyeglasses further comprise a reflector 503, which acts to direct the processed video or “super-pixels” to the eye 504.

In another embodiment of the smart eyeglasses, identified captured video field is projected on the lens panel of the eyeglasses. This embodiment is illustrated in FIG. 6. Referring to FIG. 6, smart eyeglasses 601 comprise a projector or a microprocessor 602, capable of processing a high definition video or enhanced visual picture elements, based on the information received from the digital sensors. The eyeglasses further comprise an optical or digital wave-guide 603, which acts to direct the processed video or “super-pixels” to the planar lenses 604 of the eyeglasses. In one embodiment, the optical or digital waveguide is placed on the eyeglass lens itself. In another embodiment, the optical or digital waveguide is placed around the eyeglass lens.

It may be appreciated that whether processed video is displayed on the planar lenses of the eyeglasses or directly to the eye, in both cases it works to achieve normal or better visual acuity and normal or better foveal and peripheral visual acuity. It may further be appreciated that the purpose of the system of present specification is to manage measurement of eye, neuro-bio processing and projection of super-pixels to complete the most realistic AR/VR images possible. In this regard, the present system provides a “visual operating system,” that is agnostic with regard to the kind of projection device or method employed.

In one embodiment, a microprocessor is utilized to take the data being delivered by the camera or sensors and to process the image to enhance the fovea and peripheral views. Micro-display and projection devices incorporated into the eyeglasses can then project targeted “super-pixels” specifically tailored for that specific user's visual deficiencies to digitally correct such deficiencies and to provide enhanced “super-vision.”

In an embodiment, the identified capture video field is presented to the user by use of a video chip.

In an embodiment, the method comprises using the video chip to generate highly collimated directed light beams at the micron-level size of an individual photoreceptor in a person's eye. In one embodiment, the video chip manipulates the direction of light falling on an object being viewed and, subsequently, aims the manipulated light at specific photoreceptors in the user's eye using an optical waveguide that can direct light from the video chip to the eye, taking into consideration chip placement on the smart eyeglasses or lens. The individual photoreceptor's reception allows for precise delivery of pixel data in a manner that allows the person's brain to “fill in” the data. It may be noted that the present system takes advantage of the natural ability of the brain to process images and uses the Perception Engine algorithms to supply the specific and minimum pixels, which provide enough information for the user's brain to generate an image.

The video image generated by the video chip of the present specification has both conventional pixel characteristics (brightness, RGB, etc.) along with a directionality component. Hence, as a viewer changes his view of an object, a view/image of the object generated by the video chip also changes because the relative position of the viewer with respect to the directional light corresponding to the object is changed. The video chip defines each pixel in the object's image pixel field as having all the conventional pixel values along with a directionality component defined with respect to a predetermined plane. This implies that, if a viewer views a pixel that is emanating light at an angle away from the viewer's view, the pixel/image/view would appear dark to the viewer. As the view is changed to align with the directionality component of the pixel, the view/image of the object appears brighter.

In an embodiment, the video chip is placed on one side of the smart eyeglasses. An optical waveguide is used to direct light from the video chip through a distance, around a corner and to the eye. Thus, specific pixels activated by the video chip are transmitted through the waveguide. As is known, conventional waveguides are fixed and will cause loss of directionality of the pixel light if used in the present embodiment. For example, if a pixel emits light at 15 degrees with respect to a predetermined plane and the conventional fixed waveguide is set up to channel light such that this angle is maintained, then when the video chip adjusts pixel emission such that the pixel emission angle is changed to −15 degrees with respect to the plane, the waveguide will be unable to transmit the light with the altered angle of emission.

Hence, in an embodiment a pixel specific waveguide (also referred to hereinafter as a “master channel”) is dedicated to one pixel. The master channel, which can be thought of as a tube, comprises multiple differently directed tubes, lumens or sub-channels. In various embodiments, the number of sub-channels within a master channel may range from 2 to n. The lumens of the sub-channel may extend straight along a large portion of the length of the master channel, angling proximate a distal end (that is, the end closer to the eye) to provide the angular directionality of the original pixel emission. During operation, once the pixel direction is assigned by the video chip, the pixel passes through one of the multiple sub-channels within the pixel specific master channel to maintain the direction of the pixel light. The exit trajectory of the pixel depends upon the sub-channel travelled by the pixel, which in turn depends upon the original direction assigned to the pixel by the video chip.

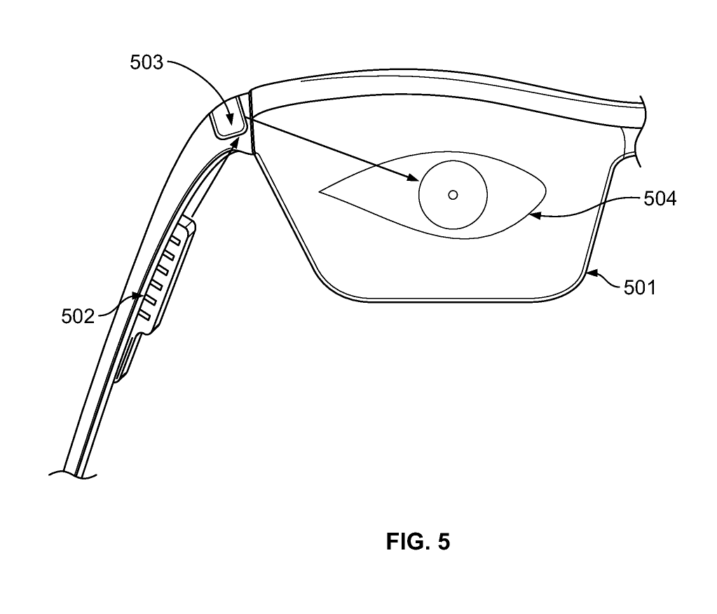

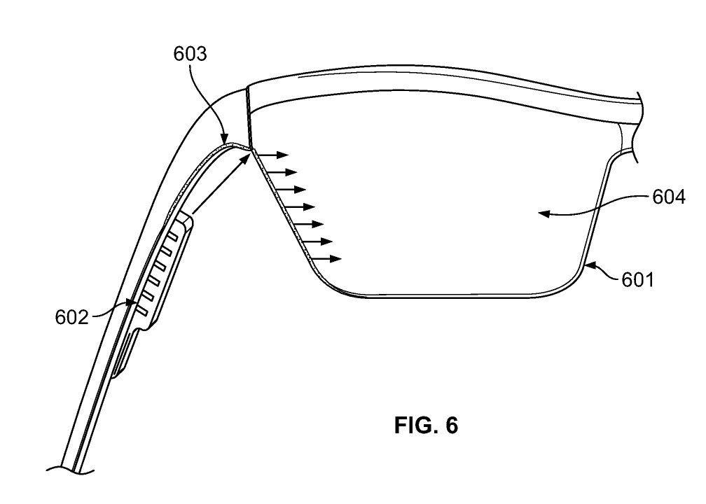

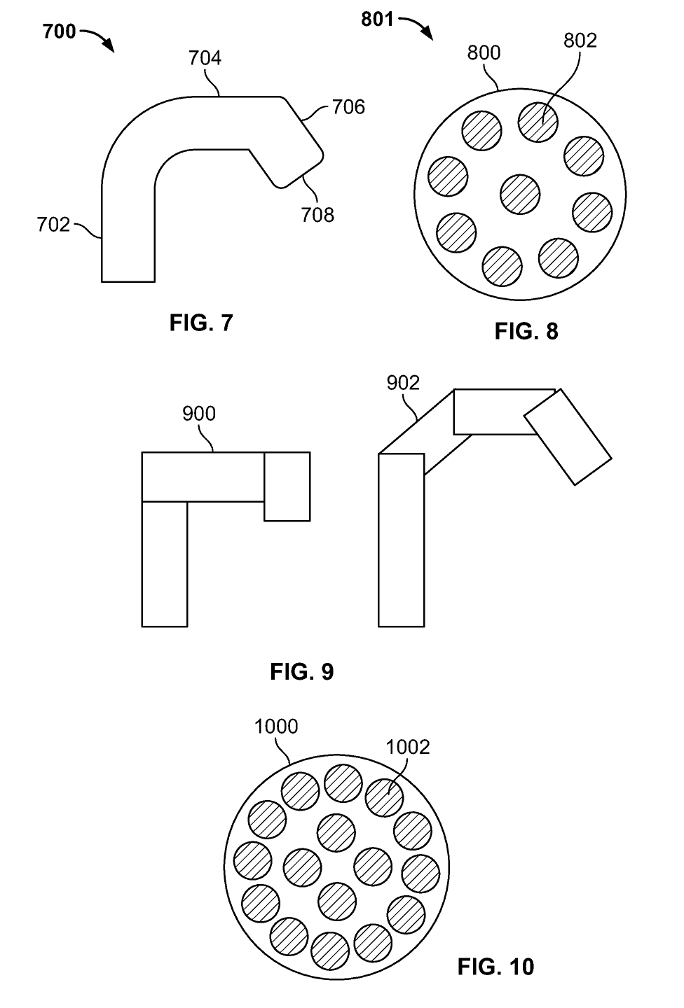

FIG. 7 is an illustration of one embodiment of a waveguide that may be used with the smart eyeglasses of the present specification. In an embodiment, a video chip is placed on one side of the smart eyeglasses. Optical waveguide 700 extends along the smart eyeglasses and is connected to the video chip at its proximal end 702, and is used to direct light from the video chip through a distance, around a corner and to the eye. In an embodiment, a center portion 704 of waveguide 700 curves near the edge of the glasses. The waveguide 700 then curves again, at its distal end 706, to direct light toward the eye through multiple different tubes, lumens, or sub-channels via an opening 708 at the distal end portion 706.

FIG. 8 is a cross-sectional view of a distal end 800 of a waveguide 801 depicting nine channels 802. In the exemplary embodiment, the waveguide 801 has nine channels, but it can have any number from 2 to n.

FIG. 9 is an illustration of various embodiments of waveguides that may be used with the smart eyeglasses of the present specification. As shown in FIG. 9, waveguides 900 and 902 show alternate paths for directing light from the video chip through a distance, around a corner and to the eye so that specific pixels activated by the video chip are transmitted through the waveguide through multiple different tubes, lumens, or sub-channels as described with respect to FIG. 7.

FIG. 10 is a cross-sectional view of a distal end 1000 of a waveguide depicting sixteen channels 1002.

e. Enabling the User to Control the Display

As the enhanced image or vide is displayed to the user, the user is also provided with controls to manipulate the display. In various embodiments, these controls may include functions such as rewind, zoom, pan, etc., lighting enhancements, face recognition or identification, as well as the option to change the visual acuity (for example from normal to enhanced) and also to change the scene being viewed. The controls are implemented by retrieving relevant video fields or portions of a video field and displaying them in accordance with user inputs. In one embodiment, the system makes use of a standard memory, such as a solid state device, to store the images for retrieval and manipulation.

In an embodiment, the glasses are coupled with a mobile app that allows a user to define certain preferences, such as automatic zoom if the user stares at one thing for more than X seconds, changing modes (see below) if the user taps the side of the glasses X times, automatic search if the user expresses a voice command (search for car—see below).

In the embodiment, using a video chip and a pixel specific waveguide for presenting an identified capture video field to a user, each view of the object is associated with a predefined set of light directionality components defining the view. The pixel specific waveguide or master channel maintains the directionality component of a view while conveying the view to the user. In an embodiment, a user may use eye movement to manipulate the image/view. For example, if a user moves his eyes to the right for two seconds image/view movement would be observed. Hence, the display method provides an augmentation of depth and dimensionality to a view/image, thereby eliminating the need for high resolution eye tracking and head tracking by use of simultaneous presentations of multiple views of an object.

In an embodiment, a user is enabled to toggle between virtual reality and enhanced reality by tinting the smart eyeglasses to block out sight. By changing a tint level of the lenses of the glasses and reducing natural scene transmission through the glasses through one or more filters, the delivered video becomes the only thing the viewer sees, moving from AR (augmented reality) to VR (virtual reality).

In an embodiment, the methods and devices of the present specification allow for at least four modes of interaction, including interaction via a mobile phone, tapping the smart eyeglasses, hand gestures, and voice command. Any of these modes of interaction, either alone or in combination, can be used to change a) modes (view, find, share), b) initiate search for something within the visual field, c) obtain information on something in the visual field, d) zooming within the visual field, etc.

It may be appreciated that apart from the above example, the uses of the present system and smart eyeglasses extend to a variety of fields including arts and entertainment, professional work, medicine—such as physicians performing surgery, helping the visually impaired and even everyday living.

In one exemplary use case scenario, a person wants to find something in the visual field. A user scans an entire visual field. The user then places system in Find Mode (as opposed to View Mode, see below). The user can select the mode using their mobile phone (wirelessly controlling the glasses), tapping the side of the glasses, waving specific hand gestures in front of the camera, or by voice. In Find Mode, the user inputs what the user is looking for, i.e. car, keys, etc. The system processes the video to find the identified object (car, keys, etc.) in the video field. The system then instructs the user to position the visual field in a particular way so that it can map the identified object from the video field to the visual field.

In another exemplary use case scenario, a person wants to improve their view of something in the visual field. The user places the system in View Mode. A user scans an entire visual field. The user can then stare at something in the visual field. In an embodiment, the user can set a “stare duration” so that the system knows that if a user stares at something for a predetermined time period, the function is “View Mode”. The system maps that to a video field. The system then provides options to the user, such as zoom, identify (edge/block processing to extract the object and send to the Internet), and other standard processing (contrast, brightness, color, hue, etc.) techniques.

In another exemplary use case scenario, a person wants to share their visual field with someone else. A user places the system in Share Mode. As the user scans their visual field, the captured video field is shared, as permitted. The people receiving that video field can then manipulate it using all the same video processing techniques.

In one embodiment, the present system allows the users to share their video field or super-images via standard social networks. Users can make their real-time video capture of their visual field public, tagged with geo-location data and shared with a defined group of friends, or posted into an existing social network. Thus, for example, if a person is attending a popular or famous event, that person can share their video field for the event, wherein the video field was captured by smart eyeglasses of the present specification. Another person wearing smart eyeglasses can then view the video field, if it is shared with them, and experience what it is like to be at the event. In one embodiment, video field sharing can be done in real-time.

The above examples are merely illustrative of the many applications of the systems, methods, and apparatuses of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A vision enhancement device for providing enhanced visual acuity, comprising:
a frame;
at least one transparent substrate positioned within said frame;
at least one digital camera positioned on said frame to capture a field of view;
at least one sensor positioned on said frame for tracking eye movements;
a processor and non-transient memory configured to store and execute a plurality of instructions, wherein, when said plurality of instructions is executed, said processor:
receives and processes data from the at least one digital camera and at least one sensor to determine characteristics of a user's eyes;
based on said characteristics, executes a perception engine to determine a minimum set of pixel data;
generates collimated light beams in accordance with said minimum set of pixel data; and
delivers the minimum set of pixel data to the user's eyes; and
at least one energy source in electrical communication with said digital camera, said sensor, and said processor.

2. The vision enhancement device of claim 1, wherein at least a portion of said collimated light beams are directed toward specific individual photoreceptors in the user's eyes.

3. The vision enhancement device of claim 1, wherein at least a portion of said collimated light beams are directed toward specific individual photoreceptors in the user's eyes using at least one of an optical waveguide, a planar lens, and a reflector.

4. The vision enhancement device of claim 1, wherein said minimum set of pixel data comprises a minimum amount of pixel data required to project a desired image to a user.

5. The vision enhancement device of claim 1 further comprising a display with sufficient resolution to project the enhanced visual picture elements onto at least one of a planar display of smart eyeglasses or onto the user's eye itself.

6. The vision enhancement device of claim 1, wherein said characteristics of the user's eyes comprise foveal and peripheral fields of focus.

7. The vision enhancement device of claim 1 further comprising at least one of a micro LED display, a quantum LED display and a pico-projection display device positioned on said frame.

8. The vision enhancement device of claim 1, wherein said minimum set of pixel data comprises a minimum amount of pixel data required to be provided to a fovea of the user to correct visual distortions caused by eye abnormalities and for enhancing a visual acuity of the user.

9. The vision enhancement device of claim 1 further comprising a video capture device, wherein said video capture device captures video corresponding to the user's field of view.

10. The vision enhancement device of claim 9, wherein the processor is configured to time sync the characteristics of user's eyes with said captured video to determine the user's areas of interest and to generate time stamped video.

11. The vision enhancement device of claim 10, wherein said processor is further configured to retrieve said time stamped video.

12. The vision enhancement device of claim 11, wherein said processor is further configured to translate coordinates from the user's field of view to the retrieved time stamped video.

13. The vision enhancement device of claim 12, wherein said processor is further configured to retrieve and display pixels in proximity to the translated coordinates in the field of view.

14. The vision enhancement device of claim 9, wherein said processor allows the user to make a real-time video capture of their visual field public, and share with a defined group of friends or post on an existing social network.

15. The vision enhancement device of claim 1, wherein said device further comprises a slider for zoom functionality.

16. The vision enhancement device of claim 1 further comprising infra-red sensors to afford seeing through certain objects.

17. The vision enhancement device of claim 1, wherein said at least one digital camera captures a field of view ranging from zero to 360 degrees.

18. The vision enhancement device of claim 1, wherein the function of delivering the minimum set of pixel data to the user's eyes is carried out by means of at least one of eyeglasses or contact lenses.

19. The vision enhancement device of claim 1, wherein said minimum set of pixel data comprises image enhancement data including at least one of darkening, lightning, correction, or contrast enhancement.

20. The vision enhancement device of claim 1, wherein said minimum set of pixel data comprises data for image identification, targeting or discrimination.

21. A method of providing enhanced visual acuity to a user by mapping a visual field of the user to a video field, wherein video corresponding to, and capturing, said video field is stored in a non-transient memory and wherein a coordinate system defining said video field overlaps with a coordinate system defining said visual field, the method comprising:
tracking a movement of an eye of the user to identify one or more locations in said visual field, wherein said one or more locations correspond with an area of interest to the user;
using a camera to capture said video;
synchronizing a timing of identifying said one or more locations with a timing of said video to generate time stamped video, wherein said time stamped video comprises said video and a time stamp of when said one or more locations were identified;
retrieving the time stamped video;
determining coordinates of said one or more locations within the coordinate system defining said visual field;
translating the coordinates of said one or more locations from user's visual field to the coordinate system of the video field to yield video field coordinates defining a plurality of objects of interest in the video field; and
based on said video field coordinates, applying a perception engine to said video to generate a modified video, wherein said perception engine visually highlights pixels that fall within said video field coordinates relative to pixels that are external to said video field coordinates, thereby visually highlighting said plurality of objects of interest.

22. The method of claim 21, wherein said perception engine comprises a software module executing block processing and edge processing techniques to remove pixels external to said video field coordinates.

23. The method of claim 21, wherein said perception engine comprises a software module executing a plurality of instructions to increase at least one of a contrast, color, brightness, luminance, or hue of the pixels that fall within said video field coordinates relative to the pixels that are external to said video field coordinates.

24. The method of claim 21, wherein said perception engine comprises a software module executing a plurality of instructions to decrease at least one of a contrast, color, brightness, luminance, or hue of the pixels that are external to said video field coordinates relative to the pixels that are within said video field coordinates.

25. The method of claim 21, wherein capturing the video of the user's visual field further comprises using at least one camera in conjunction with a video chip platform.

26. The method of claim 21, wherein tracking the eye of a user generates coordinate data defining said coordinate system for the user's visual field.

27. The method of claims 21, wherein coordinates in the coordinate system of the user's visual field and the time stamp video data are used to identify frames in the video matching the user's visual field.

28. The method of claim 21, wherein said method is achieved by using a vision enhancement device comprising a digital camera to capture the video field of view, a sensor for tracking eye movements, a processor and non-transient memory configured to store and execute a plurality of instructions, an energy source in electrical communication with said digital camera, and a planar display.

29. The method of claim 28, wherein said vision enhancement device further includes wireless transceivers and is configured to transmit and receive data from wireless networks.

30. The method of claim 29, further comprising using said vision enhancement device to connect to a remote wireless network and to retrieve information about an object of interest corresponding with the plurality of objects of interest in the video field.

31. The method of claim 21, further comprising using said vision enhancement device to connect to the Internet and to share said modified video.

32. The method of claim 21 further comprising displaying said modified video on a display and providing user controls for said display, wherein the user controls include pan, zoom, rewind, pause, play, and forward.
